(19) United States
(12) Patent Application Publication
(10) Pub. No.: US 2026/0280386 A1
(43) Pub. Date: Sep. 17, 2026

(54) MOTOR ASSEMBLY WITH AXIAL CIRCUIT ASSEMBLY AND SWITCH MOUNT

(71) Applicant: H3X TECHNOLOGIES INC., Louisville, CO (US)

(72) Inventors: Jason Jerome Sylvestre, Louisville, CO (US); Eric Paul Maciolek, Louisville, CO (US); Max Meyer Liben, Louisville, CO (US)

(21) Appl. No.: 19/166,148

(22) PCT Filed: Apr. 24, 2024
(86) PCT No.: PCT/US2024/025917

§ 371 Date: Sep. 17, 2025

Related U.S. Application Data
(60) Provisional application No. 63/461,356, filed on Apr. 24, 2023.

(51) Int. Cl. H02K 11/00; H02K 5/20; H02K 5/22

(52) U.S. Cl. CPC H02K 11/0094; H02K 5/20; H02K 5/225

(57) ABSTRACT

A motor assembly comprising a housing defining an axis; and a circuit assembly positioned at an axial end of the housing. The circuit assembly includes a plurality of switches. The plurality of switches is positioned circumferentially around the axis, and each of the plurality of switches is in contact with an inner surface of the housing.

### CROSS-REFERENCE TO RELATED APPLICATIONS

This application is a U.S. 371 national phase entry of International Patent Application No. PCT/US 2024/025917, filed Apr. 24, 2024, which claims the benefit of priority to U.S. Provisional Patent Application No. 63/461,356, filed Apr. 24, 2023, which is hereby incorporated by reference in its entirety.

### TECHNICAL FIELD

The present disclosure relates to an electrical circuit assembly for use in, for example, an integrated motor drive.

### BACKGROUND

Conventional motor assemblies include electrical components that are challenging to thermally manage because the electrical components are typically not in thermal contact with an efficient thermal conduction path to a coolant medium. For example, when making contact between a plurality of electrical switches and a single heat sink it is difficult to ensure proper thermal contact between all the electrical switches and the heat sink because of mechanical tolerances.

### SUMMARY

The disclosure provides, in one aspect, a motor assembly comprising a housing defining an axis, and a circuit assembly positioned at an axial end of the housing. The circuit assembly includes a plurality of switches. The plurality of switches is positioned circumferentially around the axis, and each of the plurality of switches is in contact with an inner surface of the housing.

In some embodiments, the housing includes a cooling channel formed therein.

In some embodiments, the cooling channel is positioned radially outward from each of the plurality of switches.

In some embodiments, each of the plurality of switches are positioned an equal distance from the axis.

In some embodiments, the plurality of switches form a ring around the axis.

In some embodiments, the motor assembly further includes an end cap coupled to the housing at the axial end of the housing.

In some embodiments, the circuit assembly further includes a first DC voltage connector extending through the end cap and a second DC voltage connector extending through the end cap.

In some embodiments, the circuit assembly includes a first circuit board, a second circuit board, a third circuit board, and a fourth circuit board.

In some embodiments, the first circuit board includes a controller; the second circuit board includes a sensor; the third circuit board includes a capacitor; and the fourth circuit board includes at least one phase output.

In some embodiments, the second circuit board is positioned between the first circuit board and the third circuit board; and the third circuit board is positioned between the second circuit board and the fourth circuit board.

In some embodiments, the circuit assembly further includes a switch mount having a base and a plurality of seats. Each of the plurality of switches is positioned within one of the plurality of seats.

In some embodiments, each of the plurality of seats is movable with respect to the base.

In some embodiments, the housing includes a wall positioned between a first cavity and a second cavity. The circuit assembly is at least partially positioned within the first cavity.

In some embodiments, the motor assembly further includes a stator at least partially positioned within the second cavity.

In some embodiments, the circuit assembly further includes a circuit board and a plurality of phase extensions coupled to the circuit board; and wherein the wall includes a plurality of apertures extending between the first cavity and the second cavity. Each of the plurality of phase extensions extends through one of the plurality of apertures.

In some embodiments, each of the plurality of phase extensions is coupled to the circuit board at a first end with a fastener, and wherein each of the plurality of extensions includes a bore at a second end opposite the first end.

In some embodiments, the motor assembly further comprises a thermal pad positioned between the circuit board and the wall.

In some embodiments, the motor assembly further comprises a thermal pin extending through the circuit board.

In some embodiments, the housing further includes a coolant inlet in fluid communication with the cooling channel and a coolant outlet in fluid communication with the cooling channel; and wherein the cooling channel helically extends along the axis.

In some embodiments, the motor assembly further comprises a spring member positioned between the circuit assembly and the housing; wherein the spring member electrically connects a portion of the circuit assembly to the housing.

The disclosure provides, in one aspect, an assembly comprising a base defining an axis. The base includes a first ramp and a second ramp. The switch mount further comprises a first seat that includes a first portion slidable along the first ramp, and a second seat that includes a second portion slidable along the second ramp. The first seat is movable with respect to the base along the axis and radially with respect to the axis, and the second seat is movable with respect to the base along the axis and radially with respect to the axis.

In some embodiments, the first seat is movable independent of the second seat.

In some embodiments, the assembly further includes a first bore positioned between the first seat and the base, and a second bore positioned between the second seat and the base.

In some embodiments, the assembly further includes a first fastener at least partially positioned within the first bore, and a second fastener at least partially positioned within the second bore.

In some embodiments, the first seat is movable with respect to the base along the axis and radially with respect to the axis in response to rotation of the first fastener about a fastener axis.

In some embodiments, the fastener axis is parallel to the axis.

In some embodiments, the base includes a first threaded bore and a second threaded bore, and wherein the first fastener is at least partially positioned within the first threaded bore and the second fastener is at least partially positioned within the second threaded bore.

In some embodiments, the base is a ring.

In some embodiments, the first seat and the second seat are part of a plurality of seats, and wherein the plurality of seats is equally spaced circumferentially around the base.

In some embodiments, the assembly further includes a first switch positioned on the first base and a second switch position on the second base.

In some embodiments, the assembly further includes a thermal interface material coupled to the first switch.

In some embodiments, the thermal interface material is a ceramic.

In some embodiments, the thermal interface material is compressible; and wherein the assembly further comprises a spacer to limit the amount of compression on the thermal interface material.

In some embodiments, the spacer is coupled to the first switch; and wherein the spacer is at least partially positioned with an aperture formed in the first switch.

In some embodiments, the base, the first seat, and the second seat are aluminum.

In some embodiments, the assembly further includes a circuit board at least partially positioned within the base.

The disclosure provides, in one aspect, a phase extension comprising a body defining an axis. The body includes a first portion configured to be electrically coupled to a circuit board, and a second portion configured to be electrically coupled to a winding. The first portion includes a first bore configured to receive a fastener and the second portion includes a second bore configured to receive the winding. The first bore and the second bore are aligned with the axis.

In some embodiments, the first portion defines a first diameter, and the second portion defines a second diameter, the second diameter is smaller than the first diameter.

In some embodiments, the second portion includes an outer cylindrical surface, and the second bore defines an inner cylindrical surface.

In some embodiments, the first portion includes planar flats positioned on an outer cylindrical surface of the first portion.

In some embodiments, the first bore is threaded, and the second portion is configured to be crimped.

In some embodiments, the first portion has a first axial end and the first bore is formed in the first axial end, and wherein the second portion has a second axial end and the second bore is formed in the second axial end.

Other aspects of the disclosure will become apparent by consideration of the detailed description and accompanying drawings.

### BRIEF DESCRIPTION OF THE DRAWINGS

These and other features, aspects, and advantages of the present technology will become better understood with regards to the following drawings. The accompanying figures and examples are provided by way of illustration and not by way of limitation.

FIG. 1 is a perspective view of a motor assembly.

FIG. 2 is a perspective view of a cross-section of the motor assembly of FIG. 1.

FIG. 3 is a perspective view of another cross-section of the motor assembly of FIG. 1.

FIG. 4 is an enlarged perspective view of a cross-section of the motor assembly of FIG. 1, illustrating a phase extension.

FIG. 5 is an end view of a cross-section of the motor assembly of FIG. 1, illustrating a plurality of switches in a switch mount.

FIG. 6 is an enlarged partial view of FIG. 5.

FIG. 7 is a perspective view of a cross-section of the motor assembly of FIG. 1, illustrating a switch positioned between a switch mount and a motor housing.

FIG. 8 is a perspective view of a circuit assembly of the motor assembly of FIG. 1.

FIG. 9 is another perspective view of the circuit assembly of FIG. 8.

FIG. 10 is a perspective view of the switch mount of the motor assembly of FIG. 1.

FIG. 11 is a perspective view of a cross-section of the switch mount of FIG. 10.

FIG. 12 is a cross-sectional view of a motor assembly, illustrating a spring positioned between a circuit board assembly and a housing.

FIG. 13 is a cross-sectional view of a switch, a thermal interface, and a spacer.

FIG. 14 is a plan view of a circuit board including thermal pins.

FIG. 15 is a perspective cross-sectional view of the circuit board of FIG. 14, illustrating a thermal pin extending through conductive planes.

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term “coupled,” as used herein, is defined as “connected,” although not necessarily directly, and not necessarily mechanically. The term coupled is to be understood to mean physically, magnetically, chemically, fluidly, electrically, or otherwise coupled, connected or linked and does not exclude the presence of intermediate elements between the coupled elements absent specific contrary language.

The term “abut” or “abuts,” as used herein, refers to contact between two components such that a thermal conduction path between the components is established. Components that abut may have a thermal interface positioned between the abutting components to further facilitate the thermal conduction path between the components. The thermal interface may include any combination of, for example, thermal grease, or thermally conductive but electrically insulating insulators (e.g., Aluminum Nitride ceramic, Kapton, etc.)

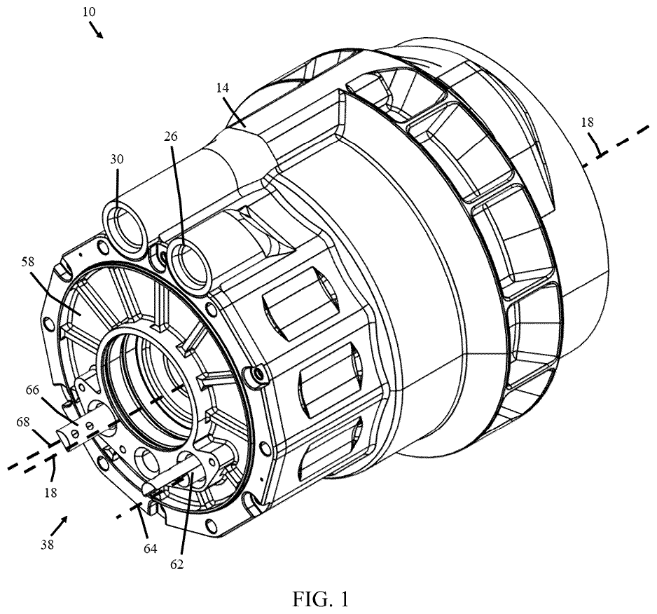

With reference to FIGS. 1-3, a motor assembly 10 includes a housing 14 defining a longitudinal axis 18. In the illustrated embodiment, the housing 14 includes a cooling channel 22 formed within the housing 14. In some embodiments, the cooling channel 22 extends helically around the housing 14 along the longitudinal axis 18. In some embodiments, the housing 14 is additively manufactured with the cooling channel 22. Such a motor assembly with a housing and cooling channel is detailed in International Application Number PCT/US2021/0157691, which is incorporated herein by reference in its entirety. In the illustrated embodiment, the housing 14 includes a coolant inlet 26 in fluid communication with the cooling channel 22 and a coolant outlet 30 in fluid communication with the cooling channel 22.

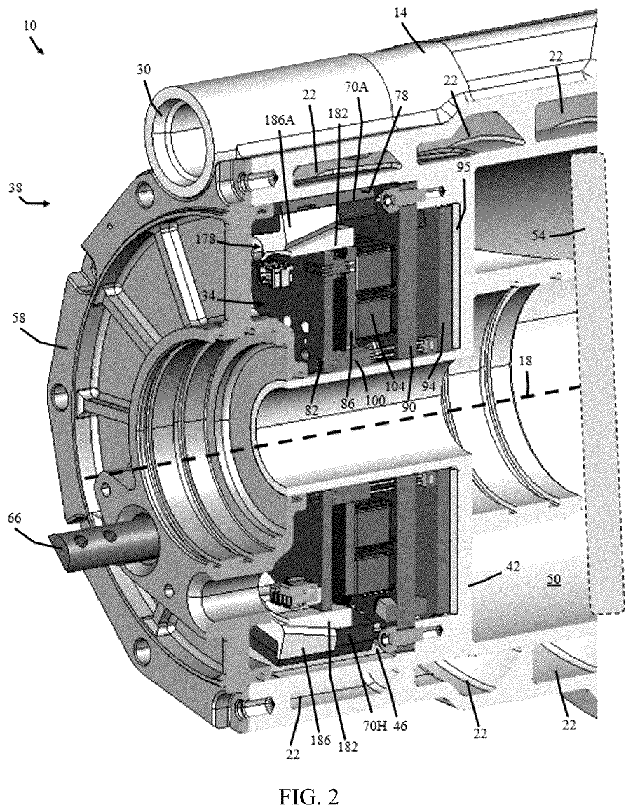

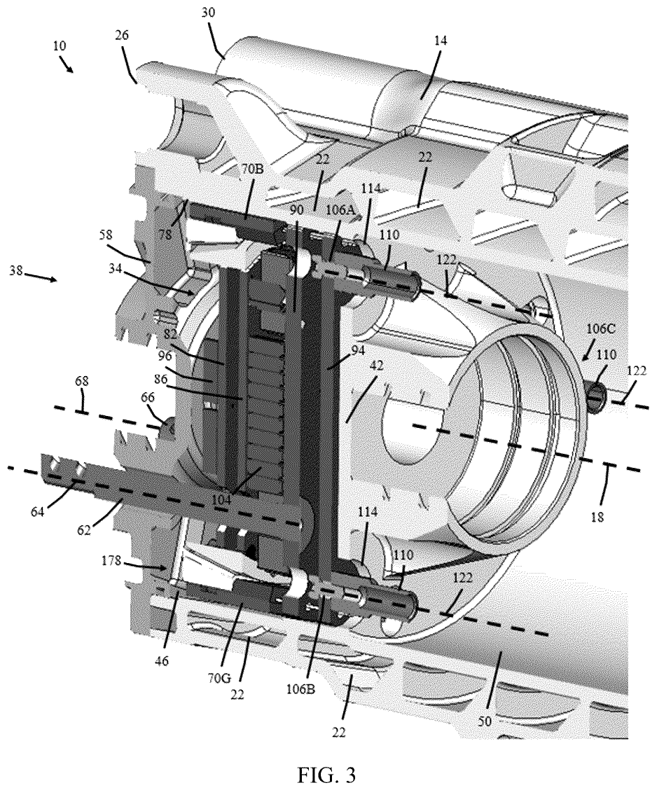

With reference to FIGS. 2 and 3, the motor assembly 10 includes a circuit assembly 34 positioned at an axial end 38 of the housing 14. The housing 14 includes a wall 42 positioned between a first cavity 46 and a second cavity 50. In some embodiments, the wall 42 is integrally formed with the housing 14. In some embodiments, the wall 42 is separately formed from the housing 14 to and later secured to the housing 14 with a fastener. In some embodiments, the wall 42 is aluminum. In the illustrated embodiment, the circuit assembly 34 is at least partially positioned within the first cavity 46. In some embodiments, the motor assembly 10 further includes a stator 54 at least partially positioned within the second cavity 50. In the illustrated embodiment, the motor assembly 10 includes an end cap 58 coupled to the housing 14 at the axial end 38 of the housing 14. As such, the end cap 58 at least partially encloses the circuit assembly 34 within the housing 14. In the illustrated embodiment, the circuit assembly 34 further includes a first DC voltage connector 62 extending through the end cap 58, and a second DC voltage connector 66 extending through the end cap 58. The first DC voltage connector 62 extends along a first axis 62, and the second DC voltage connector 66 extends along a second axis 68. In some embodiments, the first axis 64 and the second axis 68 are spaced from and parallel to the axis 18 of the housing 14. In the illustrated embodiment, the DC voltage connectors 62, 66 are solid copper round busbars. In some embodiments, the DC voltage connectors are cables.

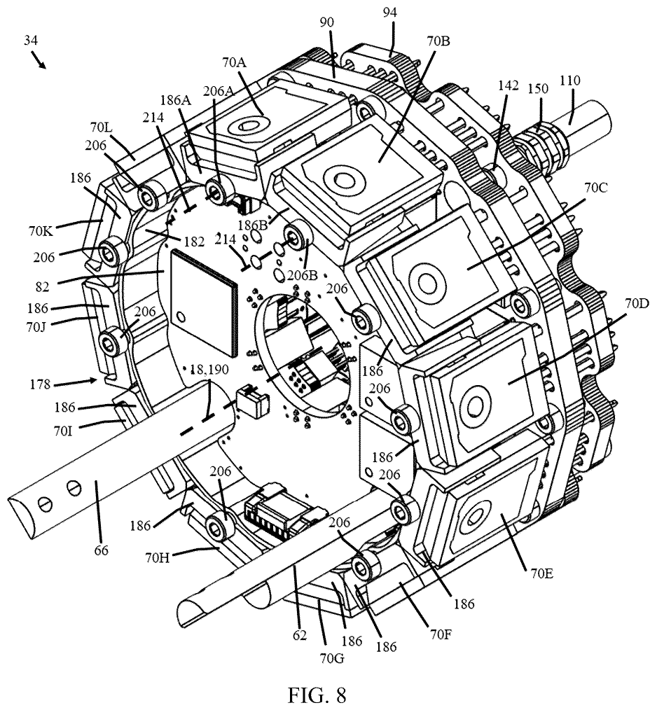

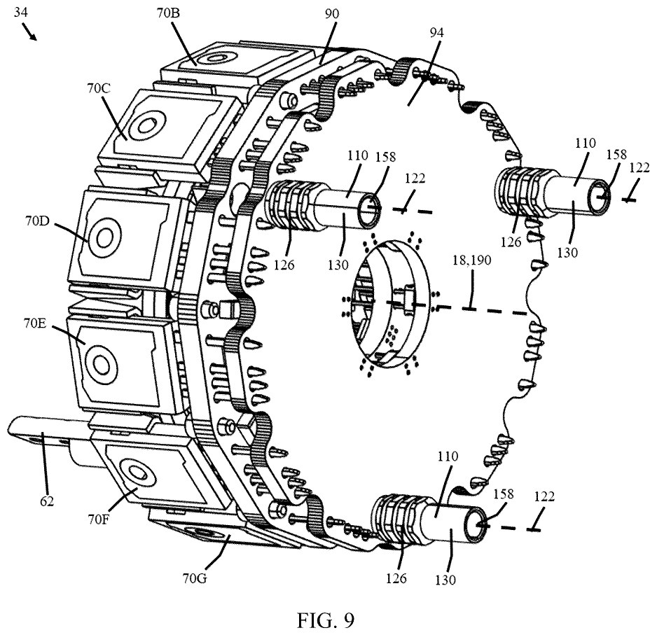

With reference to FIGS. 8 and 9, the circuit assembly 34 includes a plurality of switches 70A-70L. In some embodiments, the switches 70A-70L comprises any suitable power semiconductor device including, but not limited to, a metal-oxide-silicon transistor (MOSFET), an insulated-gate bipolar transistor (IGBT), a bipolar junction transistor (BJT), a junction field effect transistor (JFET), a thyristor, or any combination thereof.

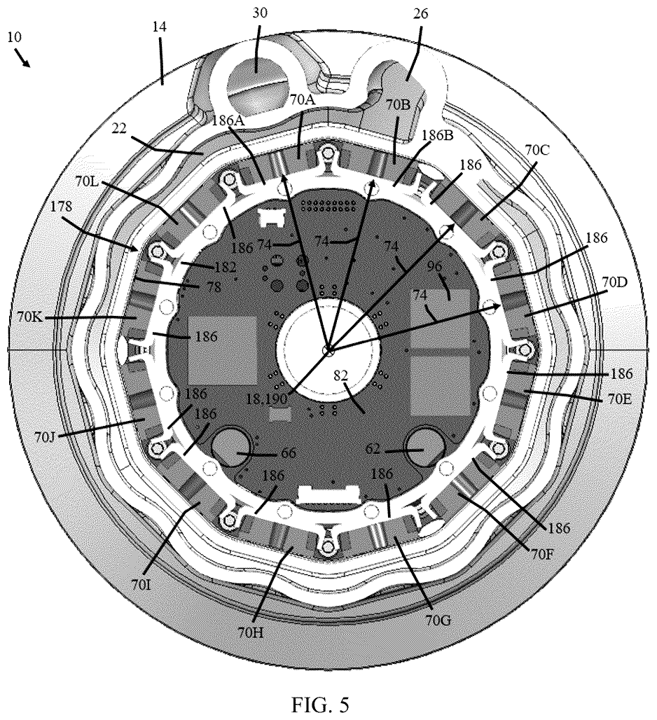

With reference to FIGS. 2, 3, and 5, the switches 70A-70L are positioned circumferentially around the axis 18. In the illustrated embodiment, the switches 70A-70L are all positioned approximately at an equal distance 74 from the axis 18 (FIG. 5). In other words, the plurality of switches 70A-70L forms a ring of switches around the axis 18.

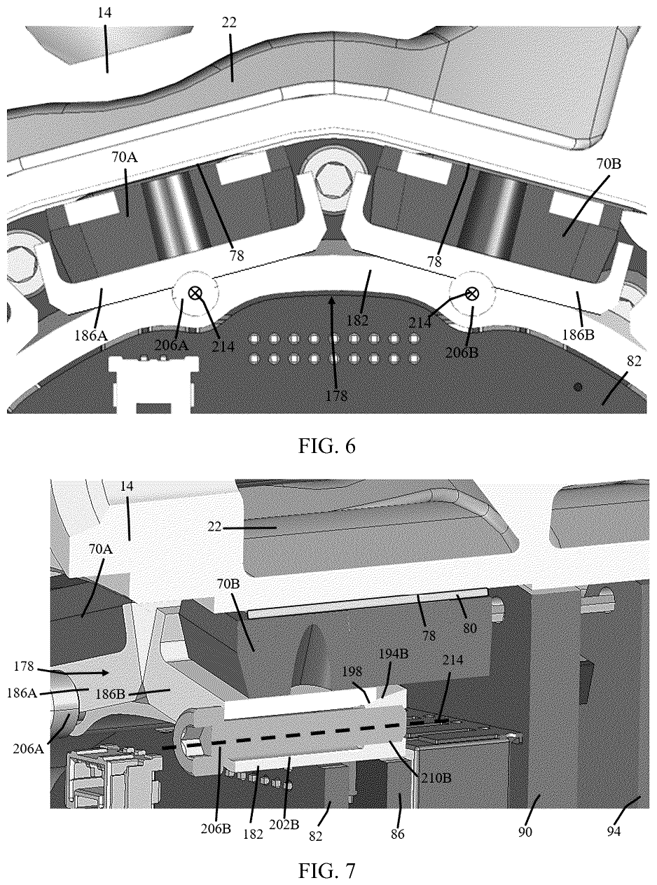

Each of the switches 70A-70L abuts an inner surface 78 of the housing 14. With reference to FIG. 5, in the illustrated embodiment, the cooling channel 22 is positioned radially outward from each of the plurality of switches 70A-70L. Advantageously, the cooling channel 22 in the housing 14 is able to effectively remove heat from each of the switches 70A-70L. In other words, the housing 14 provides an efficient thermal conduction path for heat generated in the switches 70A-70L to be removed to the coolant channel 22. In some embodiments, the cooled surface area of each switch is electrically connected to the source pin (e.g., high voltage node) of the switch. With reference to FIG. 7, in some embodiments, a thermal interface 80 is positioned between the switch 70B and the inner surface 78. In some embodiments, the thermal interface 80 includes thermal grease, a thermally conductive but electrically insulating solid insulator (e.g., Aluminum Nitride ceramic, Kapton, etc.), or any combination thereof. In one embodiment, the thermal conduction path comprises the switch 70B, a layer of thermal grease, an Aluminum Nitride ceramic, another layer of thermal grease, and the cooled inner surface 78 of the housing 14. In some embodiments, the thermal interface 80 is a soft compressible thermal material, which advantageously may not require any thermal grease and may have improved ability to withstand vibrations.

With reference to FIG. 2, the circuit assembly 34 includes a first circuit board 82, a second circuit board 86, a third circuit board 90, and a fourth circuit board 94. In the illustrated embodiment, the circuit boards 82, 86, 90, 94 are axially stacked along the axis 18. In the illustrated embodiment, the second circuit board 86 is positioned between the first circuit board 82 and the third circuit board 90. In the illustrated embodiment, the third circuit board 90 is positioned between the second circuit board 86 and the fourth circuit board 94.

In the illustrated embodiment, the first circuit board 82 is a control board. In the illustrated embodiment, the first circuit board 82 includes at least one controller 96 (e.g., a microprocessor). In some embodiments, the controller 96 is configured to selectively turn on and off each of the switches 70A-70L.

In the illustrated embodiment, the second circuit board 86 is a sensor board. In the illustrated embodiment, the second circuit board 86 includes at least one sensor 100 (e.g., a temperature sensor, a voltage sensor, a current sensor, a position sensor, etc.).

In the illustrated embodiment, the third circuit board 90 is a DC link board. In the illustrated embodiment, the third circuit board 90 includes at least one capacitor 104. In some embodiments, the capacitor 104 is a DC link capacitor. In some embodiments, the capacitor 104 is a Y-capacitor.

In the illustrated embodiment, the fourth circuit board 94 is a power board. In some embodiments, the fourth circuit board 94 includes gate drive circuitry for the switches 70A-70L. In the illustrated embodiment, the fourth circuit board 94 includes three phase voltage outputs 106A, 106B, 106C. In some embodiments, the fourth circuit board 94 includes any number of voltage phase outputs. In some embodiments, the phase voltage outputs 106A, 106B, 106C are on the third circuit board 90, as detailed further herein. In some embodiments, a thermal pad 95 is positioned between the fourth circuit board 94 and the wall 42. In the illustrated embodiment, the thermal pad 95 is a compressible thermal pad positioned at the end of the circuit assembly 34. The thermal pad 95 advantageously facilitates sinking heat out of the circuit components and into the wall 42, which is thermally well-connected to the liquid coolant.

With reference to FIG. 3, the circuit assembly 34 includes at least one phase extension 110. In the illustrated embodiment, the circuit assembly 34 includes three phase extensions 110 (e.g., one phase extension for each of the three phase voltage outputs 106A, 106B, 106C). In the illustrated embodiment, each of the phase extensions 110 is coupled to the fourth circuit board 94. The wall 42 positioned between the first cavity 46 and the second cavity 50 includes a plurality of apertures 114 that extend between the first cavity 46 and the second cavity 50. In the illustrated embodiment, each of the plurality of phase extensions 110 extends through one of the plurality of apertures 114.

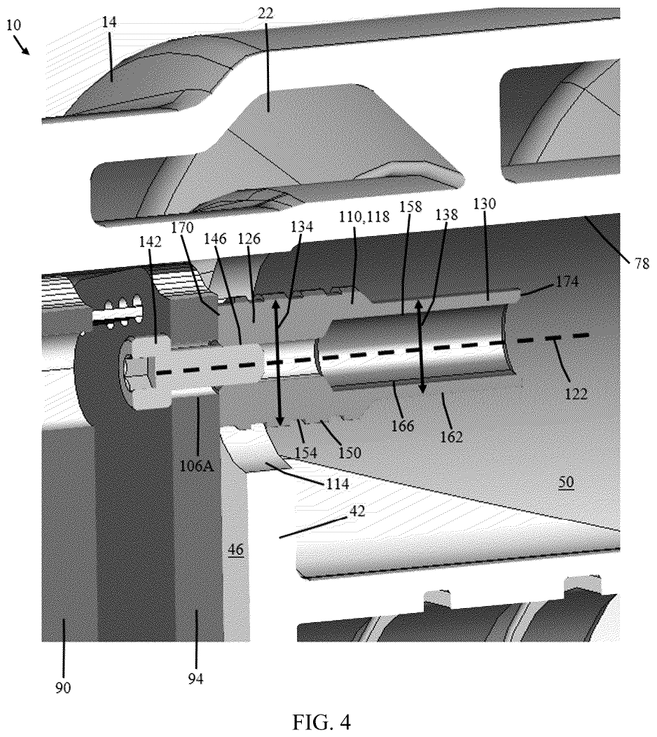

With reference to FIG. 4, the phase extension 110 includes a body 118 defining an axis 122. The body 118 includes a first portion 126 and a second portion 130. The first portion 126 defines a first diameter 134. The second portion 130 defines a second diameter 138. In the illustrated embodiment, the second diameter 138 (of the second portion 130) is smaller than the first diameter 134 (of the first portion 126).

The first portion 126 is configured to be electrically coupled to a circuit board. In the illustrated embodiment, a fastener 142 mechanically couples and electrically couples the first portion 126 to the fourth circuit board 94. The first portion 126 includes a first bore 146 configured to receive the fastener 142. In some embodiments, the first bore 146 is a threaded bore. In the illustrated embodiment, the first portion 126 includes planar flats 150 positioned on an outer cylindrical surface 154 of the first portion 126. In some embodiments, the planar flats 150 are encapsulated and the planar flats 150 advantageously provide a reaction surface against the surrounding encapsulation material in order to react to a tightening torque applied. In other words, without the planar flat 150, a purely cylindrical phase extension would break free from the encapsulant in response to application of a tightening torque.

The second portion 130 is configured to be electrically coupled to a winding (e.g., a stator winding). In the illustrated embodiment, the second portion 130 includes a second bore 158 configured to receive the winding. In some embodiments, the second portion 158 is crimped to mechanically and electrically couple the second portion 130 to the winding. In other words, the second portion 130 is configured to be crimped. The second portion 130 includes an outer cylindrical surface 162 and the second bore 158 defines an inner cylindrical surface 166.

In the illustrated embodiment, the first bore 146 and the second bore 158 are aligned with the axis 122 of the body 118. In other words, the first bore 146 is concentric with the second bore 158. The first portion 126 has a first axial end 170 and the first bore 146 is formed in the first axial end 170. In the illustrated embodiment, the first axial end 170 abuts the fourth circuit board 94. The second portion 130 has a second axial end 174, opposite the first axial end 170. The second bore 158 is formed in the second axial end 174. In the illustrated embodiment, the axis 122 of each of the phase extensions 110 is offset and parallel to the housing axis 18 (FIG. 3). In the illustrated embodiment, the axis 122 of each of the phase extensions 110 is offset and parallel to the axes 64, 68 of the DC voltage connectors 62, 66.

As detailed herein, each of the plurality of phase extensions 110 is coupled to the fourth circuit board 94 at the first axial end 170 with the fastener 142, and each of the plurality of extensions 110 includes the bore 158 (e.g., a crimping cavity) at the second axial end 174, opposite the first axial end 170. In some embodiments, the phase extension 110 is a hybrid component that is part ferrule crimped onto a winding lead and part busbar bolted to the electrical contacts of the circuit board phase outputs.

In one embodiment, the third circuit board 90 includes DC link capacitors and phase current copper layers separate from and spaced axially from the DC link capacitors and traces electrically connected with the DC link capacitors. In this embodiment, the phase extensions 110 are electrically connected to the third circuit board 90 and bypass the fourth circuit board 94. In such an embodiment, the fourth circuit board 94 includes clearance apertures through which the phase extensions 110 extend through the fourth circuit board 94 without contacting the fourth circuit board 94. In some embodiments, the fourth circuit board 94 includes gate drive circuitry for the switches 70A-70L but not the phase current.

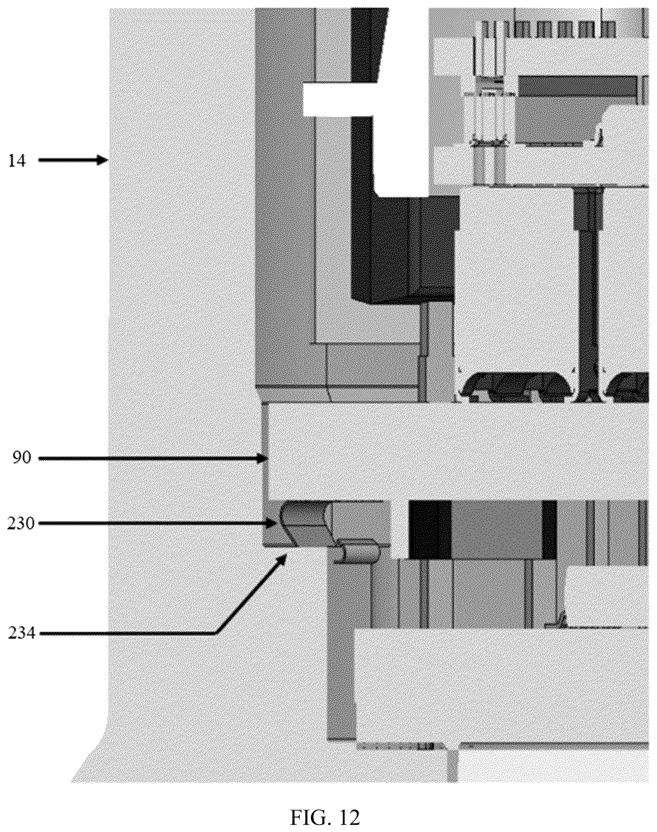

With reference to FIG. 12, in some embodiments, a spring member 230 is positioned between the circuit assembly 34 and the housing 14. In the illustrated embodiment, the spring member 230 is positioned between the third circuit board 90 and a pedestal 234 formed on the housing 14. In some embodiments, the spring member 230 is a sheet metal tab soldered to the third circuit board 90. In some embodiments, the spring member 230 electrically connects a portion of the circuit assembly 34 to the housing 14. In some embodiments, the spring member 230 acts as an electrical connection between the circuit assembly and the grounded housing. During assembly of the circuit assembly 34, the spring member 230 is compressed and ensures there is a non-stiff but low-resistance electrical connection between the third circuit board 90 and the housing 14. In some embodiments, the third circuit board 90 includes Y-capacitors that use the electrical connection through the spring members 230 to provide a low impedance path for noisy common mode currents that result from switching events.

In some embodiments, at least a portion of the circuit assembly 34 includes a thermally conductive potting material to extract heat from the printed circuit board components. In some embodiments, the potting material is soft. In some embodiments, the potting material transfers heat from the third circuit board 90 to the fourth circuit board 94.

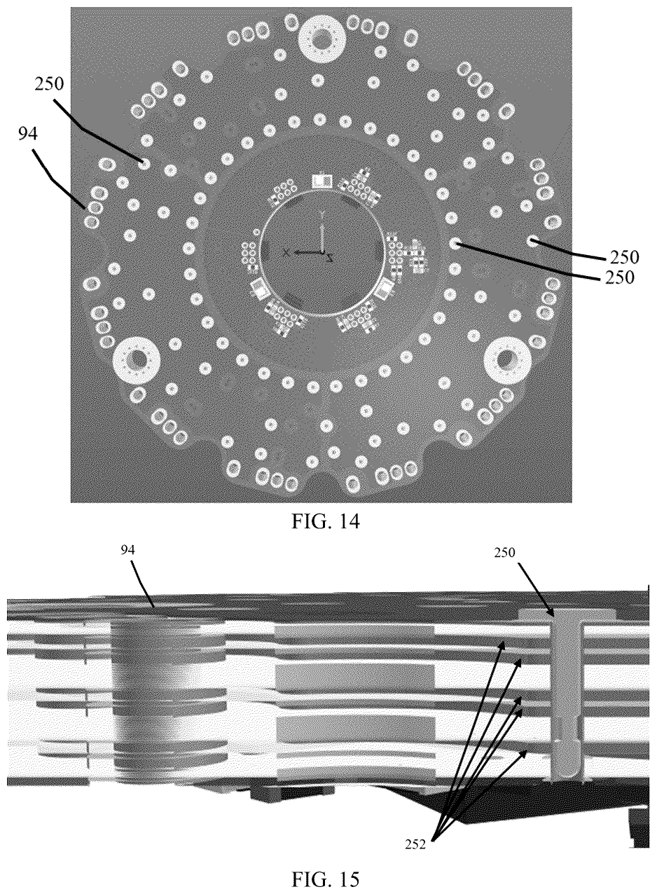

With reference to FIGS. 14 and 15, in some embodiments, a thermal pin 250 extends through the fourth circuit board 94 to improve heat extraction from the fourth circuit board 94. In some embodiments, the thermal pin 250 is copper. In the illustrated embodiment, the thermal pins 250 are distributed throughout the fourth circuit board 94. The thermal pins 250 have high thermal conductivity (e.g., approximately 400 W/m-K) and a corresponding lower thermal resistance compared to a thermal via. The thermal pins 250 are electrically conductive, so there is minimal penalty related to reducing the electrical conduction area within the interior planes 252 that carry motor phase current, for example, as compared to thermal vias that are typically filled with air or epoxy. The thermal pins 250 advantageously reduce the operating temperature of the components on the fourth circuit board 94 by connecting them more directly with the thermal pad 95 positioned between the fourth circuit board 94 and the wall 42. In some embodiments, thermal pins extend through any one or more of the circuit boards in the circuit assembly 34. In some embodiments, the thermal pin is a copper pin that is soldered inside a plated via that thermally and electrically couples multiple copper layers together better than a conventional via would.

With continued reference to FIGS. 8 and 9, the circuit assembly 34 further includes a switch mount 178 with a base 182 and a plurality of seats 186. In the illustrated embodiment, there is one seat 186 for each of the switches 70A-70L. Each of the plurality of switches 70A-70L is positioned within a corresponding one of the plurality of seats 186A-186L. For example, the first switch 70A is positioned within a first seat 186A and the second switch 70B is positioned within a second seat 186B.

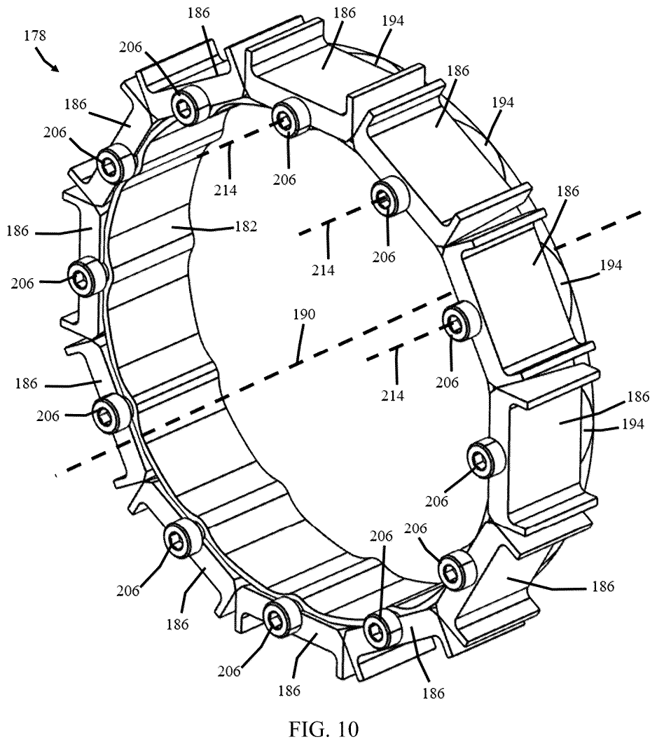

With reference to FIG. 10, in the illustrated embodiment, each of the seats 186 is movable with respect to the base 182. In the illustrated embodiment, the plurality of seats 186 is approximately equally spaced circumferentially around the base 182. In other words, the seats 186 are equally spaced apart in a circumferential direction around the base 182. For example, the second seat 186B is positioned equally between the first seat 186A and a third seat 186C.

In some embodiments, the base 182 is a ring. In the illustrated embodiment, the base 182 is positioned axially between the end cap 58 and the capacitors 104 on the third circuit board 90. In some embodiments, a foam or gel pad retains the base 182 in position relative to the circuit boards 82, 86, 90, 94.

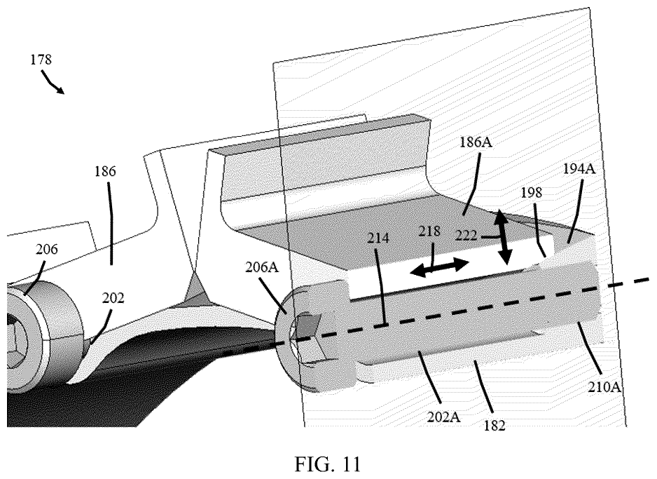

With reference to FIGS. 10 and 11, the base 182 of the switch mount 178 defines an axis 190. In the illustrated embodiment, the axis 190 is co-axial with the axis 14 of the housing 14 when the switch mount 178 is assembled in the motor assembly 10. The base 182 includes a plurality of ramps 194. For example, the base 182 includes a first ramp 194A and a second ramp 194B circumferentially spaced from the first ramp 194A. In the illustrated embodiment, the base 182 includes a ramp 194 corresponding to each of the seats 186.

Each seat 186 includes a portion that slides along a corresponding ramp 194 formed on the base 192. For example, the first seat 186A includes a first portion 198 (FIG. 11) that is slidable along the first ramp 194A of the base 192. The first seat 186A is movable with respect to the base 182 along the axis 190 and radially with respect to the axis 190. In other words, the first seat 186A is longitudinally movable (direction 218, FIG. 11) and radially movable (direction 222, FIG. 11) movable with respect to the base 182. Similarly, the second seat 186B includes a second portion (similar to the portion 198 of the first seat 186A) that is slidable along the second ramp 194B (FIG. 7) of the base 182. The second seat 186B is movable with respect to the base 182 along the axis 190 and radially with respect to the axis 190. In other words, the second seat 186B is longitudinally and radially movable with respect to the base 182. In the illustrated embodiment, each of the seats 186 is independently adjustable relative to the other seats 186. For example, the first seat 186A is movable independent of the second seat 186B. In some embodiments, each seat 186 is made of a low-creep plastic, a metal (such as aluminum), or other suitable material.

With reference to FIG. 11, the switch mount 178 includes a plurality of bores 202 positioned between each seat 186 and the base 182. For example, a first bore 202A is positioned between the first seat 186A and the base 182, and a second bore 202B is positioned between the second seat 186B and the base 182. In the illustrated embodiment, the first bore 202A is at least partially formed by the first seat 186A and the base 182. The switch mount 178 includes a plurality of fasteners 206 positioned within the bores 202. For example, a first fastener 206A is at least partially positioned within the first bore 202A and a second fastener 206B is at least partially positioned within the second bore 202B (FIG. 7).

With continued reference to FIG. 11, the base 182 includes a plurality of threaded bores 210 to receive the fasteners 206. For example, the base 182 includes a first threaded bore 210A and a second threaded bore 210B. The first fastener 206A is at least partially positioned within the first threaded bore 210A, and the second fastener 206B is at least partially positioned within the second threaded bore 210B. In the illustrated embodiment, the first seat 186A is movable with respect to the base 182 along the axis 190 and radially with respect to the axis 190 in response to rotation of the first fastener 206A about a fastener axis 214. In the illustrated embodiment, the fastener axis 214 is parallel to the axis 190. In other words, each seat 186 moves longitudinally and radially in response rotation of the corresponding fastener 206.

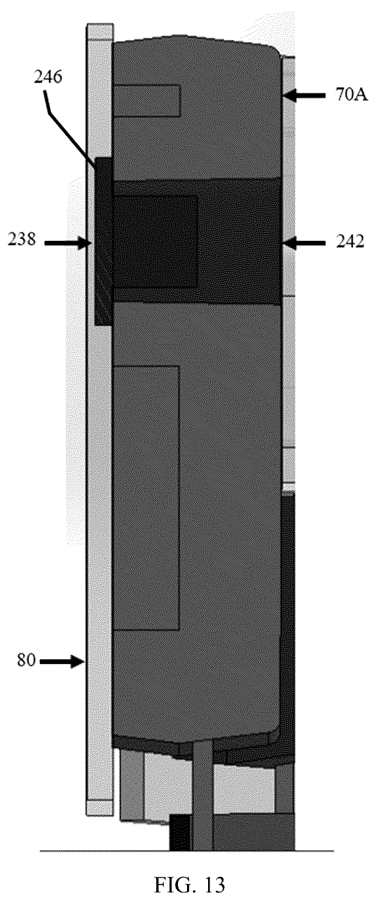

With reference to FIG. 13, in some embodiments where the thermal interface 80 is compressible, a spacer 238 is provided to limit the amount of compression on the thermal interface 80 during assembly. For example, a spacer 238 is coupled to the switch (e.g., switch 70A), and the spacer 238 is at least partially positioned within an aperture 242 formed in the first switch 70A. In some embodiments, the aperture 242 formed in the switch 70A is conventionally used for mounting the switch with a fastener. In the illustrated embodiment, the spacer 238 is “top-hat” shaped, with a brim 246 that controls the maximum compression of the thermal interface 80. In other words, as the seats are tightened down on the base 182, the thermal interface 80 (which is initially thicker than the brim 246) compresses until the thermal interface 80 is the same thickness as the brim 246, at which point the brim 246 prevents any further compression of the thermal interface 80. Advantageously, the spacer 238 prevents the thermal interface 80 from becoming over-compressed, which can make the material susceptible to vibration induced failures such as tearing.

Advantageously, thermal connection between each of the switches 70A-70L and the inner surface 78 of the housing 14 is ensured as each of the seats 186 is independently adjusted relative to the base 182. For example, the first seat 186A for the first switch 70A is adjustable to ensure contact between the first switch 70A and the inner surface 78. Independent adjustment of each seat 186 is advantageous to control the compression of each switch 70A-70L. In some embodiments with the thermal interface 80 positioned between the switch 70A-70L and the housing 14, independent adjustment of each seat 186 is advantageous to ensure the tolerance stack up in the thermal interface 80 does not prevent a desired compressive force from being maintained across all switches 70A-70L simultaneously.

Various features and advantages are set forth in the following claims.

What is claimed is:

1. A motor assembly comprising:
a housing defining an axis; and
a circuit assembly positioned at an axial end of the housing, the circuit assembly includes a plurality of switches;
wherein the plurality of switches is positioned circumferentially around the axis, and each of the plurality of switches is in contact with an inner surface of the housing.

2. The motor assembly of claim 1, wherein the housing includes a cooling channel formed therein.

3. The motor assembly of claim 1, wherein the cooling channel is positioned radially outward from each of the plurality of switches.

4. The motor assembly of claim 1, wherein each of the plurality of switches are positioned an equal distance from the axis.

5. The motor assembly of claim 1, wherein the plurality of switches form a ring around the axis.

6. The motor assembly of claim 1, further comprising an end cap coupled to the housing at the axial end of the housing.

7. The motor assembly of claim 6, wherein the circuit assembly further comprises a first DC voltage connector extending through the end cap and a second DC voltage connector extending through the end cap.

8. The motor assembly of claim 1, wherein the circuit assembly includes a first circuit board, a second circuit board, a third circuit board, and a fourth circuit board.

9. The motor assembly of claim 8, wherein the first circuit board includes a controller; wherein the second circuit board includes a sensor; wherein the third circuit board includes a capacitor; and wherein the fourth circuit board includes at least one phase output.

10. The motor assembly of claim 9, wherein the second circuit board is positioned between the first circuit board and the third circuit board; and wherein the third circuit board is positioned between the second circuit board and the fourth circuit board.

11. The motor assembly of claim 1, wherein the circuit assembly further includes a switch mount having a base and a plurality of seats; wherein each of the plurality of switches is positioned within one of the plurality of seats.

12. The motor assembly of claim 11, wherein each of the plurality of seats is movable with respect to the base.

13. The motor assembly of claim 1, wherein the housing includes a wall positioned between a first cavity and a second cavity, wherein the circuit assembly is at least partially positioned within the first cavity.

14. The motor assembly of claim 13, further comprising a stator at least partially positioned within the second cavity.

15. The motor assembly of claim 13, wherein the circuit assembly further includes a circuit board and a plurality of phase extensions coupled to the circuit board; and wherein the wall includes a plurality of apertures extending between the first cavity and the second cavity; and wherein each of the plurality of phase extensions extends through one of the plurality of apertures.

16. The motor assembly of claim 15, wherein each of the plurality of phase extensions is coupled to the circuit board at a first end with a fastener, and wherein each of the plurality of extensions includes a bore at a second end opposite the first end.

17. The motor assembly of claim 15, further comprising a thermal pad positioned between the circuit board and the wall.

18. The motor assembly of claim 15, further including a thermal pin extending through the circuit board.

19. The motor assembly of claim 1, wherein the housing further includes a coolant inlet in fluid communication with the cooling channel and a coolant outlet in fluid communication with the cooling channel; and wherein the cooling channel helically extends along the axis.

20. The motor assembly of claim 1, further comprising a spring member positioned between the circuit assembly and the housing; wherein the spring member electrically connects a portion of the circuit assembly to the housing.

21. An assembly comprising:
a base defining an axis, wherein the base includes a first ramp and a second ramp;
a first seat includes a first portion slidable along the first ramp;
a second seat includes a second portion slidable along the second ramp;
wherein the first seat is movable with respect to the base along the axis and radially with respect to the axis;
wherein the second seat is movable with respect to the base along the axis and radially with respect to the axis.

22. The assembly of claim 21, wherein the first seat is movable independent of the second seat.

23. The assembly of claim 21, further comprising a first bore positioned between the first seat and the base, and a second bore positioned between the second seat and the base.

24. The assembly of claim 23, further comprising a first fastener at least partially positioned within the first bore, and a second fastener at least partially positioned within the second bore.

25. The assembly of claim 24, wherein the first seat is movable with respect to the base along the axis and radially with respect to the axis in response to rotation of the first fastener about a fastener axis.

26. The assembly of claim 25, wherein the fastener axis is parallel to the axis.

27. The assembly of claim 24, wherein the base includes a first threaded bore and a second threaded bore, and wherein the first fastener is at least partially positioned within the first threaded bore and the second fastener is at least partially positioned within the second threaded bore.

28. The assembly of claim 21, wherein the base is a ring.

29. The assembly of claim 28, wherein the first seat and the second seat are part of a plurality of seats, and wherein the plurality of seats is equally spaced circumferentially around the base.

30. The assembly of claim 21, further including a first switch positioned on the first base and a second switch position on the second base.

31. The assembly of claim 21, further comprising a thermal interface material coupled to the first switch.

32. The assembly of claim 31, wherein the thermal interface material is a ceramic.

33. The assembly of claim 31, wherein the thermal interface material is compressible; and wherein the assembly further comprises a spacer to limit the amount of compression on the thermal interface material.

34. The assembly of claim 33, wherein the spacer is coupled to the first switch; and wherein the spacer is at least partially positioned with an aperture formed in the first switch.

35. The assembly of claim 21, wherein the base, the first seat, and the second seat are aluminum.

36. The assembly of claim 21, further including a circuit board at least partially positioned within the base.

37. A phase extension comprising:
a body defining an axis, the body includes a first portion configured to be electrically coupled to a circuit board, and a second portion configured to be electrically coupled to a winding;
wherein the first portion includes a first bore configured to receive a fastener and the second portion includes a second bore configured to receive the winding; and
wherein the first bore and the second bore are aligned with the axis.

38. The phase extension of claim 37, wherein the first portion defines a first diameter, and the second portion defines a second diameter, the second diameter is smaller than the first diameter.

39. The phase extension of claim 37, wherein the second portion includes an outer cylindrical surface, and the second bore defines an inner cylindrical surface.

40. The phase extension of claim 39, wherein the first portion includes planar flats positioned on an outer cylindrical surface of the first portion.

41. The phase extension of claim 37, wherein the first bore is threaded, and the second portion is configured to be crimped.

42. The phase extension of claim 37, wherein the first portion has a first axial end and the first bore is formed in the first axial end, and wherein the second portion has a second axial end and the second bore is formed in the second axial end.
